(19) United States
(12) Patent Application Publication
(10) Pub. No.: US 2009/0034272 A1
(43) Pub. Date: Feb. 5, 2009

(54) Light fixture

(75) Inventors: Markus Gorres, Dortmund (DE); Matthias Bremerich, Lennestadt (DE)

Correspondence Address: K.F. ROSS P.C., 5683 RIVERDALE AVENUE, SUITE 203 BOX 900, BRONX, NY, 10471-0900, US

(73) Assignee: ERCO Leuchten GmbH

(21) Appl. No.: 11/888,630

(22) Filed: Aug. 1, 2007

(51) Int. Cl. F21V 7/04

(52) U.S. Cl. 362/346

(57) ABSTRACT

A light fixture (10) is described and illustrated. The special feature consists in the fact that faceted segments (14a, 14b, 14c, 14d, 14e, 14f, 14g, 14h, 14i, 14j, 14k, 14l, 14m, 14n) having a cylindrical surface (OF) are situated on the inner surface (30) of a dish-shaped, curved reflector (21). The cylinder axes (m, m₁, m₂, m₃, m₄) of the segments are oriented in such a way that, according to the differing spacing of the segment to a vertex region (S) of the reflector (21), the orientation of the segment with respect to a tangent (T₁, T₂, T₃, T₄), which may be applied to the exterior (38) of the reflector (21) in a connecting region (15b, 15f, 15i, 15n) of the segment on the reflector, varies.

The invention relates to a light fixture for illuminating building surfaces or portions thereof or exterior surfaces in accordance with the preamble to claim 1.

A light fixture in accordance with the preamble of claim 1 is based on applicant's German patent application DE 10 2004 042 915 A1.

The known light fixture has a reflector that has numerous facet-like segments in its interior. Each segment has a surface that is inwardly concavely arcuate and that can have a spherical, cylindrical, or nonspherical basic shape.

A reflector described in DE 199 10 192 A1 serves for reflecting light beams and also has a plurality of internal facet-like segments.

Proceeding from the above-described light fixture, the object of the invention consists of further developing a light fixture in accordance with the preamble to claim 1 such that it is better able to control illumination intensity distribution.

This object is achieved according to the invention by the features of claim 1, in particular the features of the characterizing part, accordingly characterized in that

a) the segments have a reflective surface of basically cylindrical shape, a respective cylinder axis being associated with each cylindrical segment,

b) multiple cylindrical segments are positioned between a vertex region and a free edge region of the reflector,

c) the cylinder axes are aligned at an acute angle with respect to the longitudinal central axis of the reflector, whereby the alignment of the cylinder axes varies according to the differing spacing of the segment from the vertex region,

d) a respective tangent at the exterior of the reflector in a respective connecting region of a cylindrical segment on the reflector forms a deviation angle with the cylinder axis of the associated segment, and

e) the deviation angle varies according to the differing spacing of the segment from the vertex region.

The light fixture according to the invention is used for the illumination of surfaces of buildings or portions of buildings or exterior surfaces. The light fixture according to the invention is used in particular for the illumination, particularly in a uniform manner, of floor and/or wall and/or ceiling areas of a building. When the light fixture according to the invention is designed as an outdoor light fixture, road surfaces, landscaped areas, or parking areas, for example, may also be illuminated. The light fixture according to the invention is similarly used for lighting objects such as pictures or statues.

The light fixture essentially comprises a dish-shaped, curved reflector, in particular a parabolic reflector, i.e. a reflector having an essentially parabolic cross section. It is also advantageous for the reflector to have a basic shape that is rotationally symmetrical about its longitudinal central axis.

A light source may be provided in the interior of the reflector. This may be an HIT lamp, for example an HIT-TC-CE or other metal halide lamp, or alternatively, one or more LEDs. In addition, multiple HIT lamps may be provided in the interior of the reflector. It is advantageous for only one lamp to be inserted through an opening in the reflector, in particular through an opening provided in the vertex region of the reflector, in the interior of the reflector. Besides HIT lamps, low-voltage halogen incandescent lamps such QT9, QT12, or QT16 lighting means may be used. It is particularly preferable to use essentially point-shaped light sources, i.e. lighting means that emit light from a particularly small volume.

Numerous faceted segments are provided on the inner surface of the reflector. The inner surface of the reflector may be occupied completely or only partially, i.e. along specific partial regions, by faceted segments. For example, it is possible for only one circumferential angular region of 90°, for example, i.e. a quarter-circle segment, to be occupied by faceted segments, and for the remaining three-quarter circular area of the reflector to have an essentially smooth design.

Each segment has a surface that is curved toward the interior. At least some of the segments have a reflective surface of basically cylindrical shape. This means that the segments are produced from a body that is in the form of a sectional body originates from a cylindrical body, in particular a regular cylinder. A cylinder axis may be associated with each cylindrical segment. The cylinder axis is the longitudinal central axis of the cylindrical base body, or is parallel thereto. Each cylindrical base body is preferably a regular cylindrical base body.

The reflective surface of the cylindrical segment is the surface section of the cylindrical segment that contributes to the reflection of light rays emitted from the light source. The reflective surface is curved about the longitudinal central axis of the cylindrical base body.

In the sense of the present patent application, a cylinder axis refers to any axis that extends parallel to the longitudinal central axis of the cylindrical segment.

Multiple cylindrical segments are provided between the vertex region of the reflector and a free edge region of the reflector. These cylindrical segments may be located directly adjacent one another, and thus merge into one another in the manner of a staircase or a sawtooth structure. It is also possible for two cylindrical segments to be set at a spacing from each other, is with a flat or smooth surface or a segment having a different, noncylindrical curvature being provided between the cylindrical segments that are set at a spacing from one another.

In the light fixture according to the invention, the cylinder axes are aligned with respect to the longitudinal central axis of the reflector at an acute angle, i.e. an angle less than 90°. The cylindrical segments are thus positioned in such a way that their cylinder axes intersect the longitudinal central axis of the reflector at an acute angle. The alignment of the cylinder axes relative to the longitudinal central axes of the reflector varies for the various segments according to the differing spacing from the vertex region of the reflector.

A connecting region is associated with each segment. The connecting region of a segment refers to the region of the segment at which the segment is connected on the reflector. This may be, for example, the head region of the particular cylindrical segment, i.e. the region of the cylindrical segment that is closest to the vertex region of the reflector, or alternatively, a lateral region of the particular cylindrical segment. The connecting region of a segment is preferably the respective region of a segment that is closest to the reflector. A tangent to the exterior of the reflector may be applied in any connecting region of a segment on the reflector. The exterior of the reflector is understood to be the side of the reflector facing away from the interior. In this regard it is assumed that the exterior of the reflector is not textured, and that the reflector has a very thin wall thickness. In the case of a textured exterior of the reflector, the tangent is applied on an imaginary curve, for example a parabola, which defines the basic shape of the reflector.

A deviation angle is defined by the tangent and the cylinder axis of the associated segment. This deviation angle is preferably an acute angle, and varies according to the differing spacing of the segments from the vertex region of the reflector.

In other words, the cylindrical segments are situated and oriented in such a way that when viewed through a cross section of the reflector the longitudinal sides, i.e. the lateral surfaces, of the cylinder, which contribute to the optical deflection of light are oriented such that they form a polyline structure that differs from the basic shape of the reflector.

Thus, for example, by the use of a reflector having essentially a parabolic curvature and by appropriate positioning of the cylindrical facets a reflector having an elliptical basic shape may be simulated. This allows, for example, a compact design of the reflector compared to a reflector having an elliptical cross section, and thus enables a light fixture to be designed with a small installation depth.

On the other hand, practically any given luminous intensity distribution may be produced by positioning the cylindrical facets according to the teaching of the invention. For example, a luminous intensity distribution may be achieved that has a completely uniform design within a specified light field. Alternatively, if the light fixture is used for illuminating floor and wall areas, such as in a room of a building, the wall may be illuminated in a particularly uniform manner. This is achieved by reflecting portions of the light toward an upper wall area.

The use of facets having a cylindrical reflective surface allows a particularly uniform luminous intensity distribution, creating a “soft light,” since light beams are diverged upon striking the cylindrically curved surface. At the same, use of cylindrical segments having different deviation angles allows the luminous intensity distribution to be influenced in the desired manner.

Positioning of the facets in such a way that the deviation angle varies according to the differing spacing of the segments from the vertex region of the reflector allows specific portions of the light to be deflected upward or downward in a targeted manner. The terms “upward” and “downward” refer to a ceiling-mounted installation of the reflector, viewing the reflector in cross section. In other words, portions of the light may be arbitrarily deflected at any given angle with respect to the longitudinal central axis of the reflector by means of different deviation angles in the segments. The luminous intensity distribution may thus be varied in the desired manner.

According to a further advantageous embodiment of the invention, the light source has a point-shaped design. This involves a light source that has an essentially point-shaped design, i.e. that emits light from a very small volume. Metal halide lamps such as an HIT-TC-CE lamp, QT lamps in the form of low-voltage halogen incandescent lamps, or at least one LED lamp may be advantageously used as light sources. Of course, multiple lighting means or a group of lighting means may be provided in the interior of the reflector, preferably close to or in the focal point of the reflector. This allows, on the one hand, an especially good luminous intensity distribution that may be specified in advance, and on the other hand, a high luminous flux.

According to a further advantageous embodiment of the invention, the reflector has an essentially parabolic cross section. The reflector is consequently designed as a parabolic reflector. The reflector advantageously has a basic shape that is essentially rotationally symmetrical. In other words, without taking into account the possibly asymmetrical arrangement of the segments, the dish shape of the reflector is formed by a body that is essentially rotationally symmetrical about the longitudinal central axis of the reflector.

As a result, the reflector advantageously has an essentially circular light exit opening. The reflector is attached to the light fixture, whereby the free edge of the reflector may be overlapped, for example, by a portion of the housing for the light fixture and/or an attachment means, for example a screw. If the light fixture is designed as a ceiling-mounted installation or down light, the free edge region of the reflector may, for example, terminate flush with the surface of the ceiling.

According to one advantageous embodiment of the invention, the radii of curvature of the segments vary along a row. A row refers to an arrangement of the segments in a circular ring about the longitudinal central axis of the reflector. For the case in which the segments are arranged along the entire inner surface of the reflector, the rows, or at least some of the rows, may be closed. If the segments are arranged along only one circumferential angular region of the inner surface of the reflector, the rows may likewise extend only over one circumferential angular region of the inner surface of the reflector.

By varying the radii of curvature of the segments along a row, when rotationally symmetrical reflectors and essentially point-shaped lights are used luminous intensity distributions may be achieved that differ from a rotational symmetry. For example, luminous intensity distributions having an essentially oval design may be produced that are particularly suited, for example, for illuminating parking areas or for use in light fixtures as sculpture spotlights, i.e. for illumination of sculptures or similar objects.

The light fixtures may also be situated directly on a ceiling in a building and be designed as a down light.

Alternatively, the light fixture may be attached directly to a ceiling in a room of a building by means of a conductor track. In the latter two application examples, the light fixture is able to simultaneously illuminate the region of a wall of a building room and the region of a floor of the room. For the case that only one wall of a room and a portion of a floor are to be illuminated, the radii of curvature of the segments vary along a row in such a way that, for example, a quarter-circle segment of the interior of the reflector is occupied by cylindrical facets having a first radius, and the other segments in the remaining three-quarter circle, corresponding to an approximately 270° circumferential region of the reflector, are occupied by segments having different radii of curvature.

By special positioning of the cylindrical facets in the above-mentioned quarter-circle circumferential region, it is possible to illuminate the wall to be lit in a particularly uniform manner and also to a great vertical height. By use of such a light fixture, the end result is the production of a nonrotationally symmetrical luminous intensity distribution.

A comparable light fixture may also be designed for illumination of two oppositely situated wall regions in the room of a building, for example an elongated corridor, with simultaneous illumination of regions of the floor as well. In such an embodiment the entire inner surface of the reflector is divided into four segments, resulting in a double plane of symmetry of the reflector, specifically, a symmetry with respect to two planes passing through the longitudinal central axis of the reflector that are perpendicular to one another and that intersect in the longitudinal central axis of the reflector.

According to a further embodiment of the invention, the radii of curvature of the segments are all the same along a row. In particular by use of such an embodiment of the invention, particularly uniform luminous intensity distributions may be produced, in particular essentially rotationally symmetrical luminous intensity distributions, which are virtually constant along the illuminated surface.

The radii of curvature of the segments may vary or remain constant along a column. A column refers to an arrangement of segments along the same circumferential angular region that is adjacently situated between the vertex region and the free edge region of the reflector. The particular luminous intensity distribution that is desired determines whether the radii of curvature of the segments vary or are held constant along a column. For example, the radius of curvature of the segments along a column may be altered to achieve a relatively narrowly radiating light cone, or alternatively, a greatly expanded light cone.

According to one advantageous embodiment of the invention, the cylindrical segments extend along a partial region of the inner surface of the reflector, or along multiple partial regions of the inner surface of the reflector. Thus, for example, it is possible for only a quarter-circle segment of approximately 90°, for example, of the inner surface of the reflector to be occupied by cylindrical segments, whereas the remaining three-quarter circular region (270°) of the reflector has an essentially smooth design. Thus, for example, a reflector may be easily produced having a luminous intensity distribution that in the desired manner differs from that of a facet-free reflector. Alternatively, the inner surface of the reflector may be occupied by cylindrical and spherical or aspherical segments in combination. Thus, a first circumferential angular region of the reflector may be occupied by cylindrical facets, and another circumferential angular region of the reflector may be occupied by spherical or aspherical segments.

Lastly, the cylindrical segments may also extend along the entire inner surface of the reflector.

According to a further embodiment of the invention, the deviation angle varies in such a way that segments that are near the free edge region of the reflector have a larger deviation angle than segments near the vertex. By use of such a configuration, a particularly large number of portions of light may be reflected outward by a large spacing, i.e. for a ceiling-mounted installation, upward by a large spacing, so that upper wall regions of a wall are illuminated as well.

According to a further embodiment of the invention, the cylindrical segments have radial undercuts, at least in places. This means that at least two adjacent segments along a column, i.e. in the axial direction, are configured in such a way that, viewed in the axial direction, overlapping is achieved. This allows a particularly advantageous positioning of the cylindrical facets such that some portions of the light emitted by the light source are emitted so as to pass very close to the free edge region of the reflector. For example, when the light fixture is used as a down light that is intended to also illuminate the wall regions of a room area, very high vertical areas of the wall regions may be illuminated in this manner.

It is particularly advantageous for the reflector having the cylindrical segments to be an aluminum reflector that is manufactured by a pressing method. By use of suitable novel tools according to the invention it is possible for the first time to achieve an undercut configuration.

The cylindrical segments may be situated along annular rows running in the circumferential direction, and along radial columns extending from the vertex region to the edge region. Segments in two respective spaced rows may define a conversion [sic; circumferential] angular offset.

Additional advantages of the invention are seen in the other dependent claims as well as with reference to the following description of a plurality of embodiments that are shown in the figures.

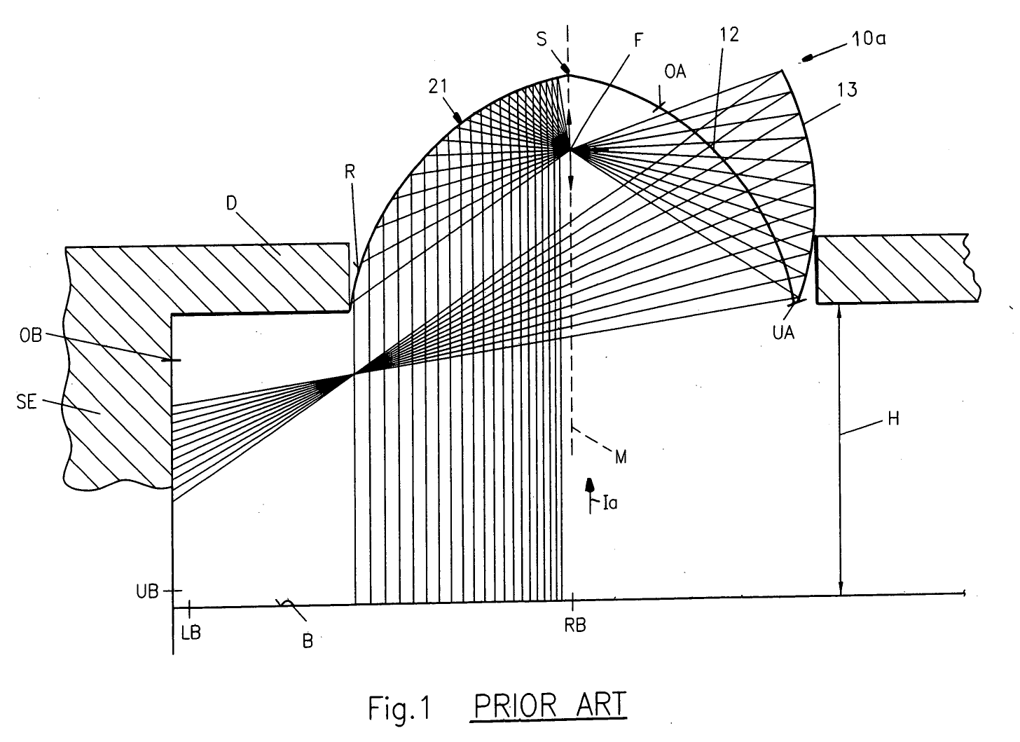

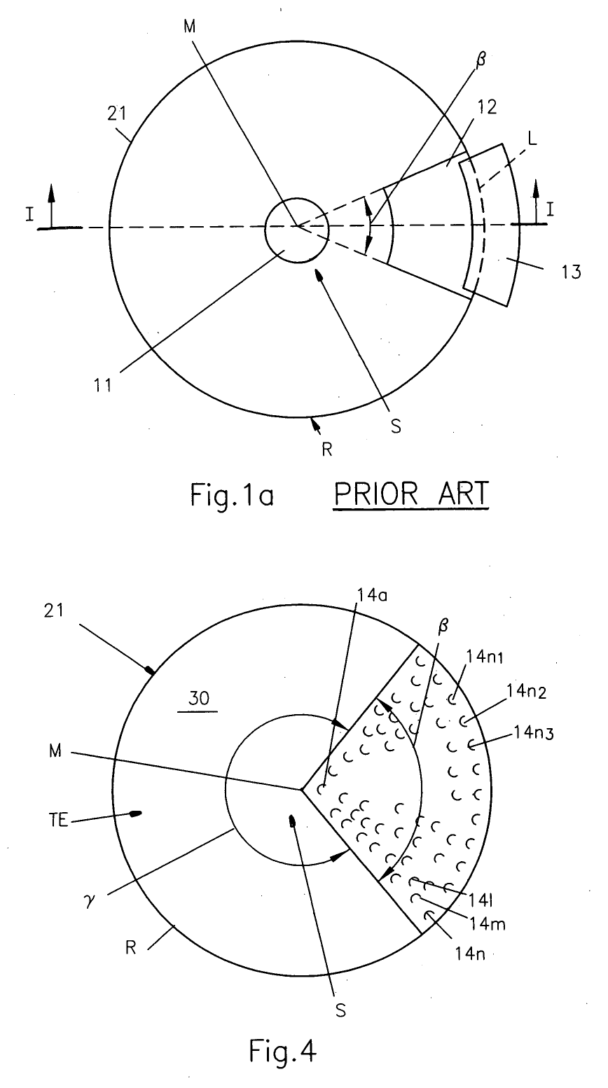

FIG. 1 is a schematic partially sectional view of a prior-art light fixture;

FIG. 1a is a top view of only the reflector of the light fixture from the prior art, approximately in the direction of arrow Ia like FIG. 1;

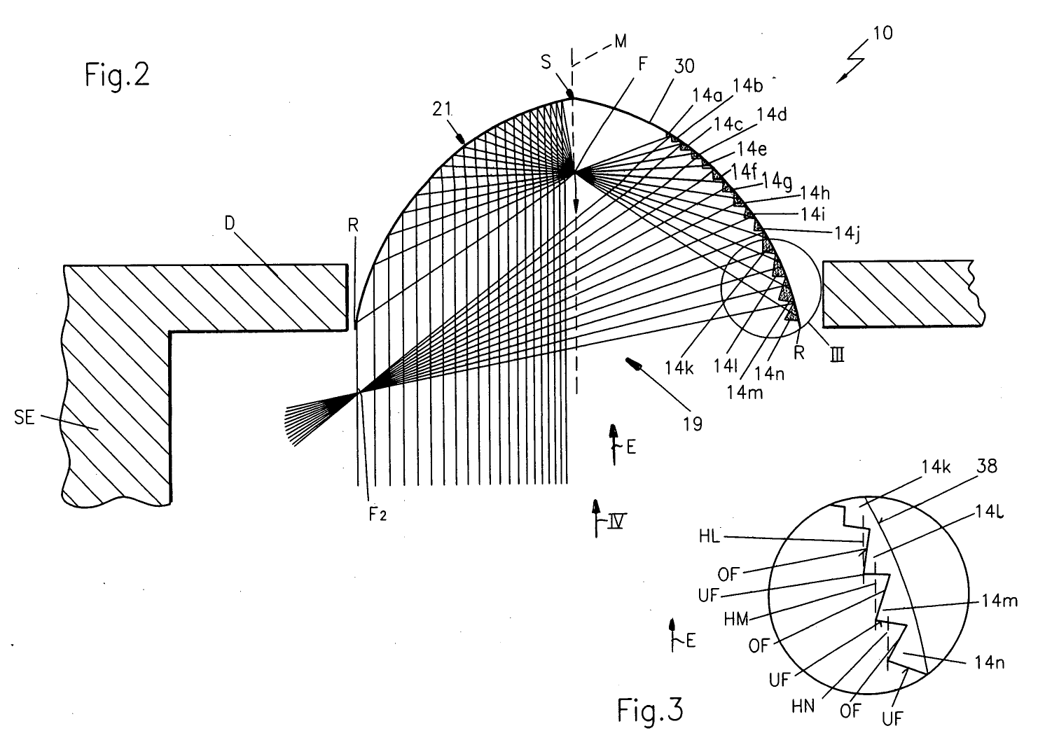

FIG. 2 is a schematic view similar to FIG. 1 of a first embodiment of an inventive light fixture;

FIG. 3 is an enlarged cross-sectional view in accordance with circled region III in FIG. 2;

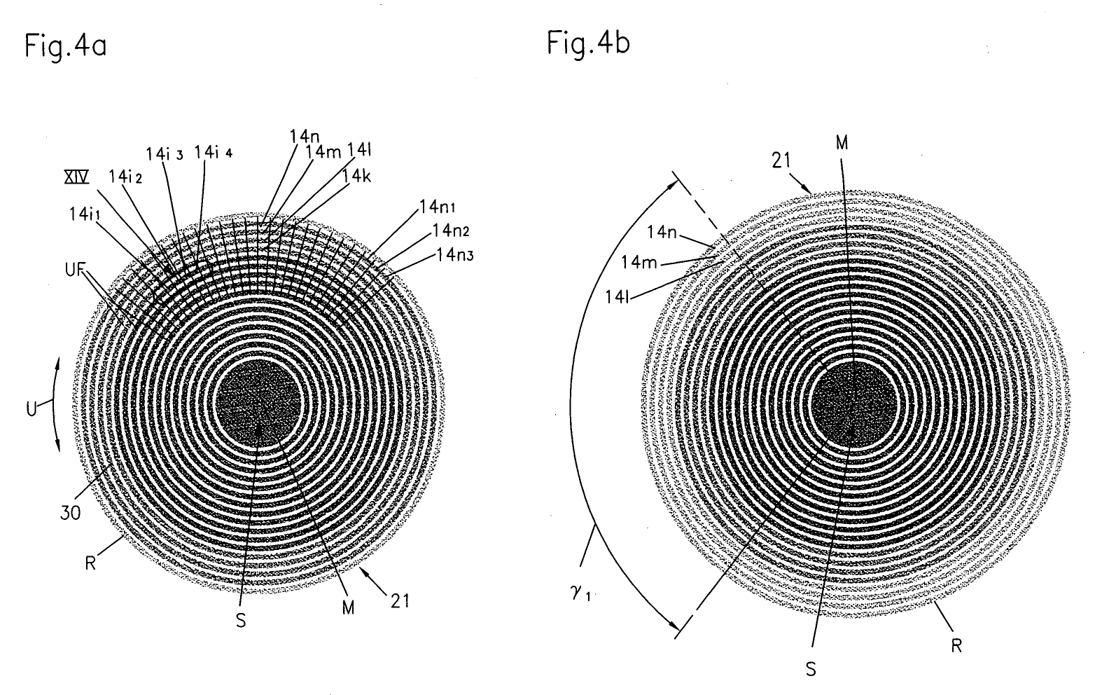

FIG. 4 is an embodiment of a reflector for an inventive light fixture in accordance with arrow IV in FIG. 2 in a very schematic view;

FIG. 4a is a second embodiment of a reflector for an inventive light fixture in a view similar to FIG. 4;

FIG. 4b is another embodiment of a reflector for an inventive light fixture in a view like FIG. 4;

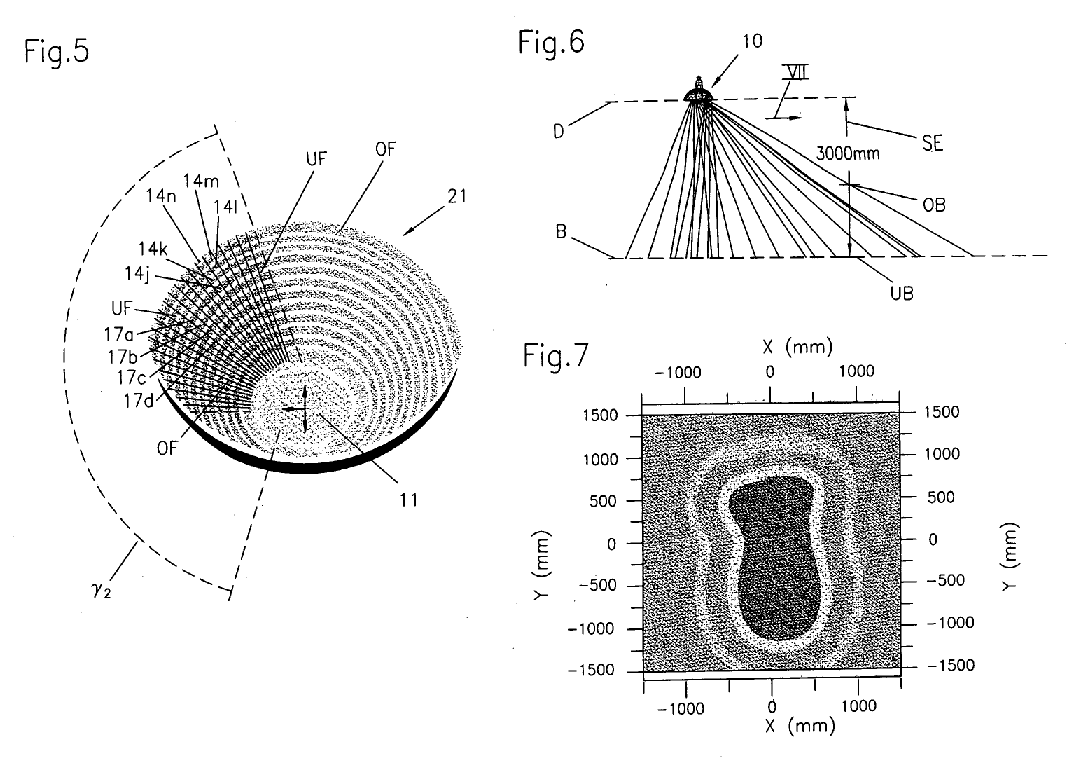

FIG. 5 is another embodiment of a reflector for an inventive light fixture, in a perspective view;

FIG. 6 is a very schematic view like FIG. 1 of a light fixture having the of FIG. 5 and mounted in a ceiling;

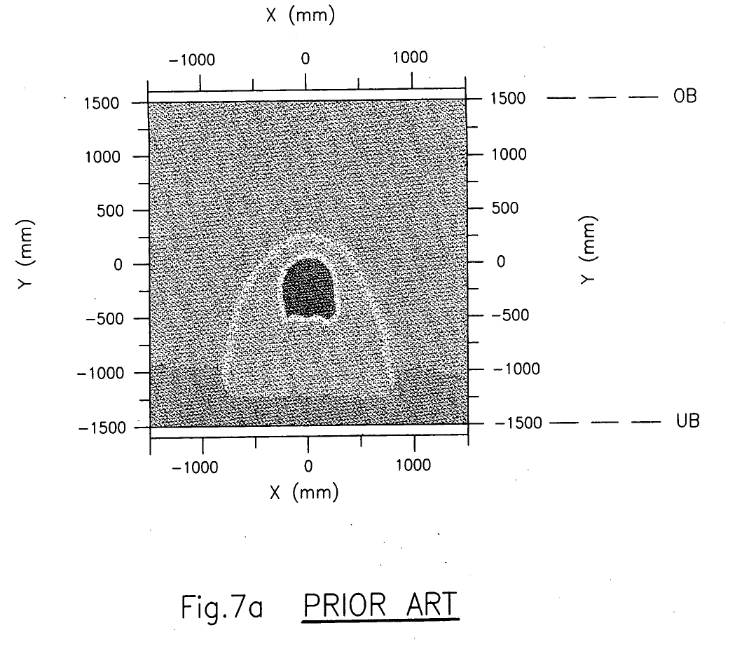

FIG. 7 is a false color representation of the illumination intensity distribution that the light fixture in FIG. 6 produces on a side wall indicated by the double-headed arrow of FIG. 6;

FIG. 7a is a view like FIG. 7 of the illumination intensity distribution that a light fixture from the prior art would produce with a rotation-symmetrical, facet-free reflector on the wall indicated by the double arrow in FIG. 6;

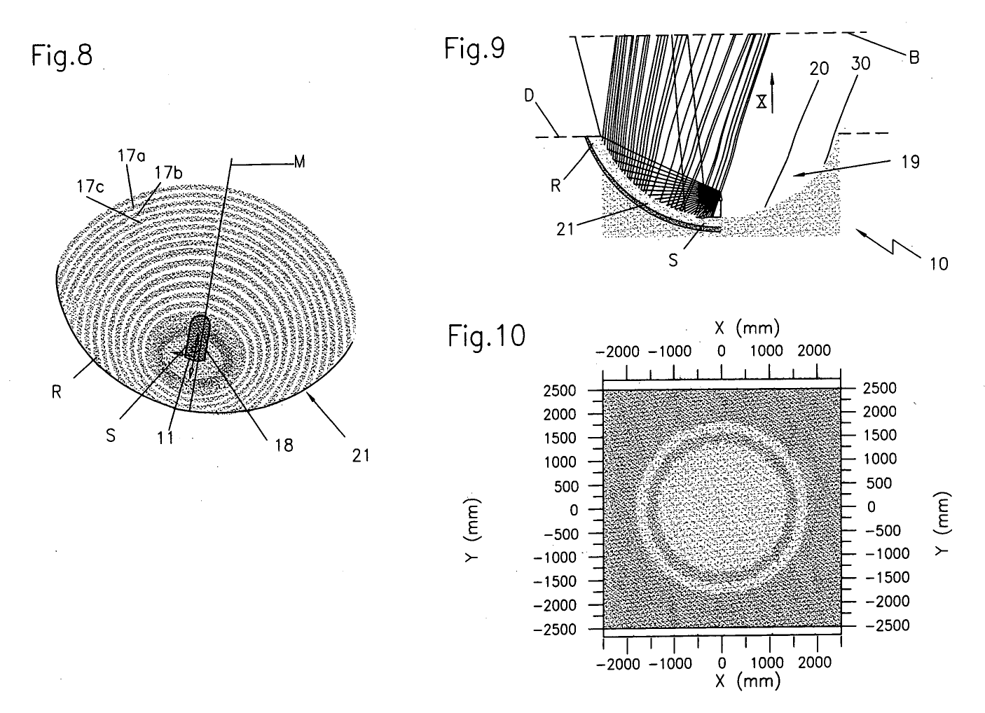

FIG. 8 is another embodiment of a reflector for an inventive light fixture, shown as in FIG. 5;

FIG. 9 is a schematic view illustrating as an example the paths light beams in a view similar to FIG. 6 for a light fixture having a reflector like FIG. 8;

FIG. 10 shows the illumination intensity distribution on a floor that can be attained with a light fixture like FIG. 9;

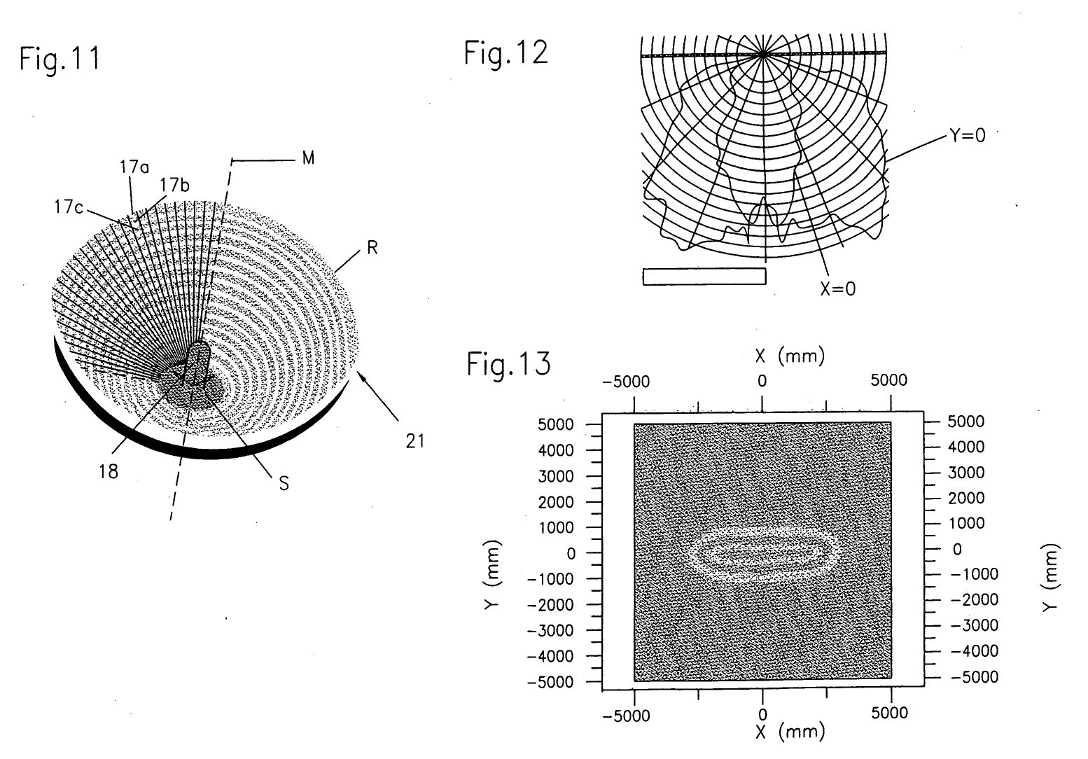

FIG. 11 shows another embodiment of a reflector for an inventive light fixture in a view like FIG. 8;

FIG. 12 shows the light distribution curves for a light fixture having a reflector like FIG. 11 in a polar view along two mutually perpendicular viewing planes;

FIG. 13 shows the illumination intensity distribution on a floor for a light fixture like FIG. 12 in a view like FIG. 10;

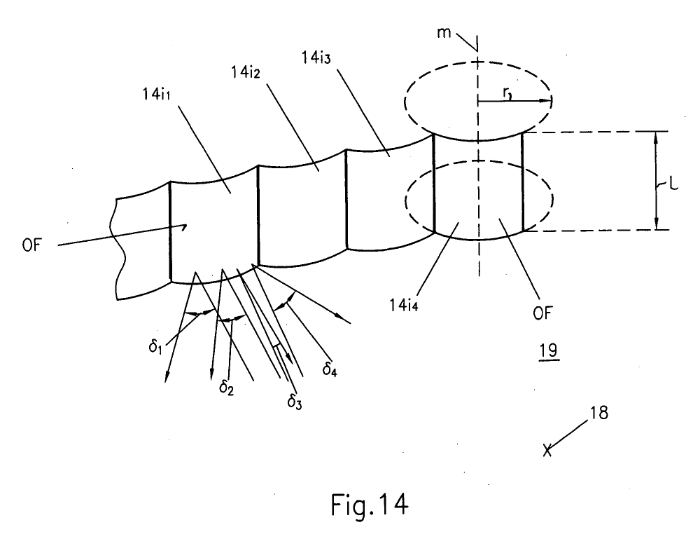

FIG. 14 is an enlarged schematic view of a cutout from a row of facets in accordance with cutout circle XIV in FIG. 4a;

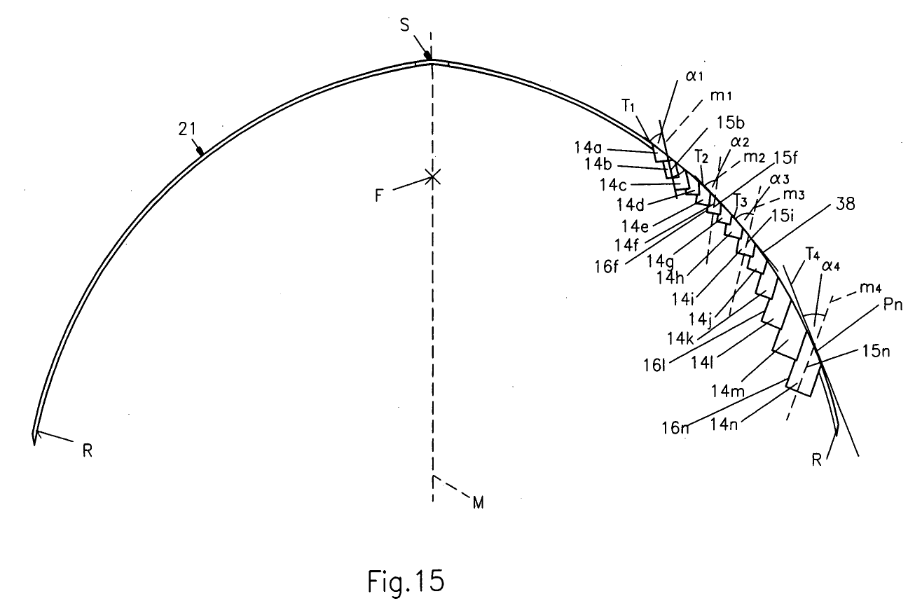

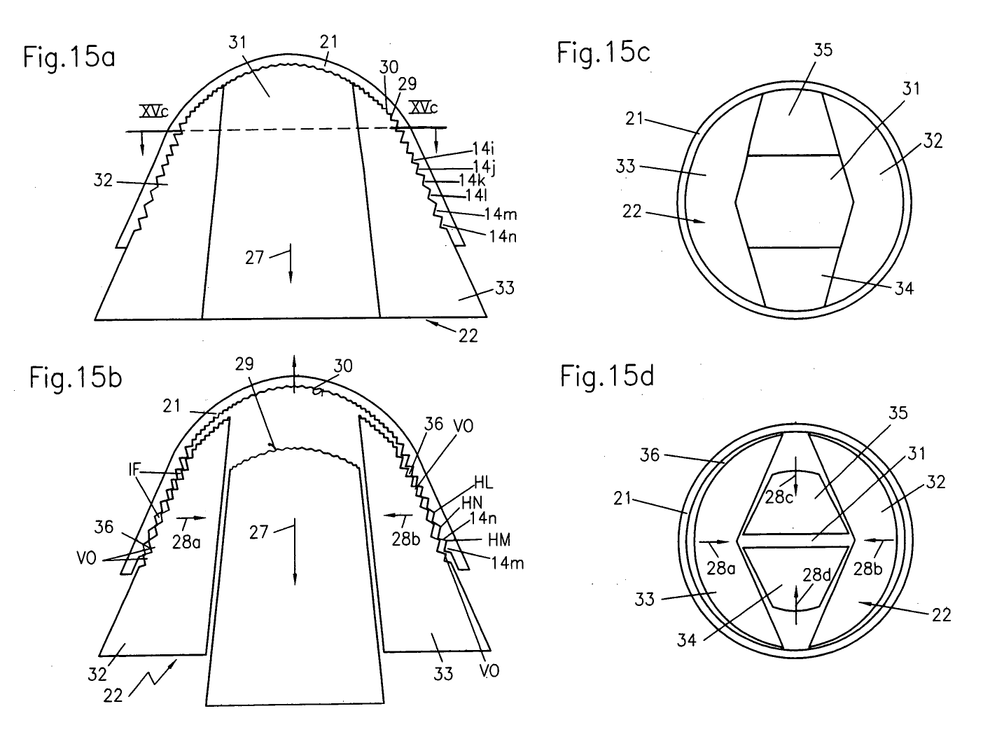

FIG. 15 shows the inventive light fixture like FIG. 2 in a simplified view;

FIG. 15a is an inventive die whose external shape forms the interior of the reflector as the result of a pressing process;

FIG. 15b shows the embodiment in FIG. 15a with a retractile center part;

FIG. 15c is another embodiment of an inventive five-part die in a partial section, schematic top view, approximately in accordance with sectional line XVc-XVc in FIG. 15a;

FIG. 15d shows the embodiment in FIG. 15c, with retracted center tool parts;

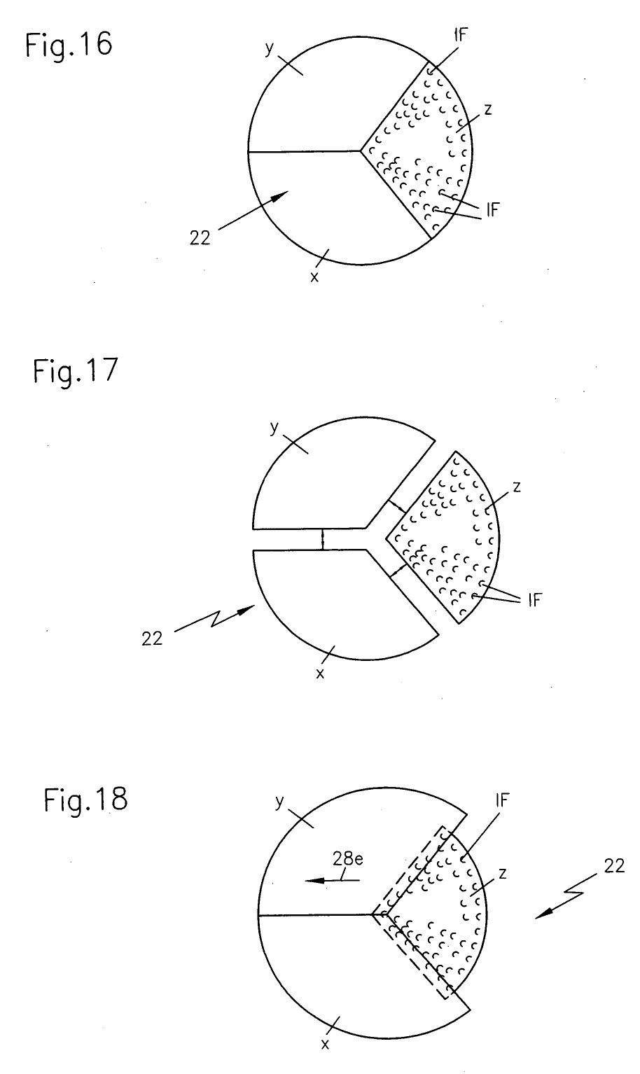

FIG. 16 is a schematic view like FIG. 15c of another embodiment of an inventive three-part die;

FIG. 17 is another embodiment of an inventive die like the die of FIG. 16, the three tool parts being spaced apart from one another radially;

FIG. 18 is another embodiment of an inventive die similar to FIG. 16, where one of the three tool parts is shifted radially inward;

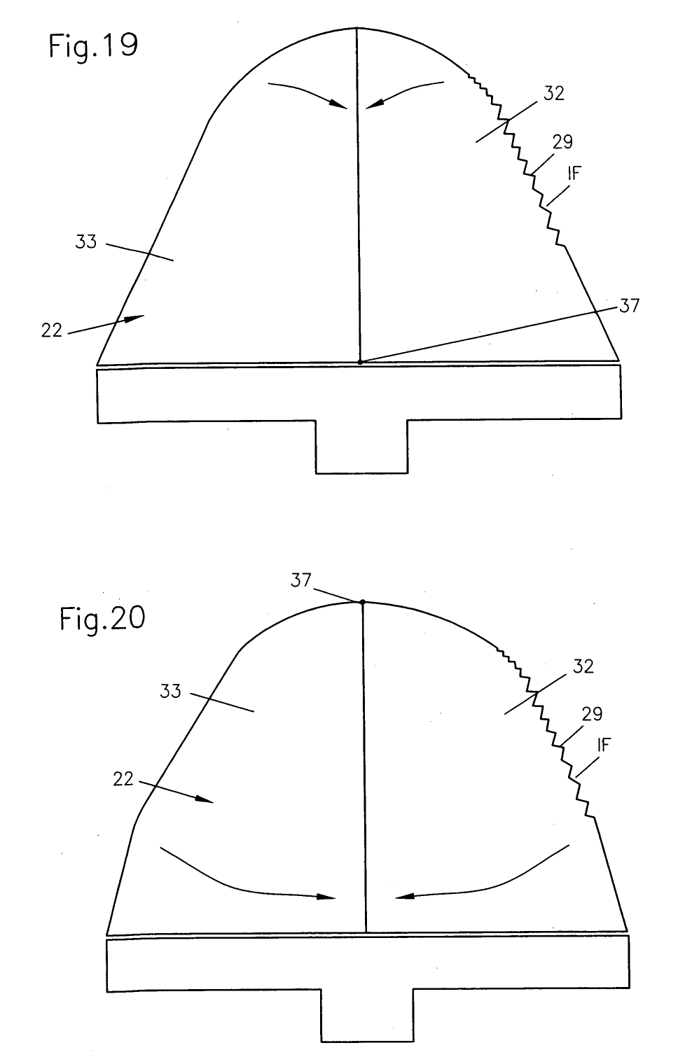

FIG. 19 is another embodiment of an inventive die in which two tool parts are pivotal relative to each other about a lower pivot axis in a foot of the die;

FIG. 20 is a view similar to FIG. 19 of another embodiment of an inventive die in which the two tool parts can be pivoted about a pivot axis that is located near the apex point of the die;

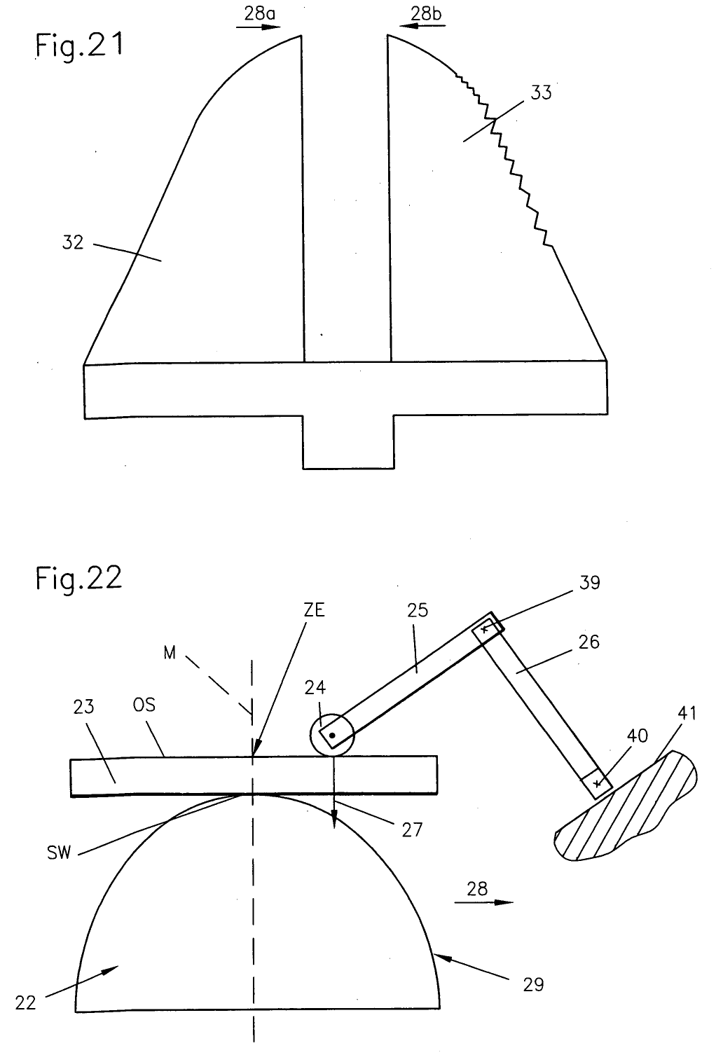

FIG. 21 is another embodiment of an inventive die in which at least two tool parts can be displaced radially relative to one another; and

FIG. 22 is a die and an aluminum disk arranged in the region of the apex and a pressing apparatus.

The inventive light fixture identified at 10 in the figures is described in the following. It should be initially noted that for the sake of clarity comparable parts or elements have been labeled with the same reference numbers, sometimes with the addition of lower case letters and/or numbers as subscripts. This also applies to the prior-art light fixture.

First a light fixture from applicant's prior art will be described with reference to FIGS. 1 and 1a.

As shown in FIG. 1, a light fixture 10a from the prior art is intended to be installed in a ceiling D of a room in a building. The light fixture includes light-emitting means (not shown) that is arranged at a focal point F or near a focal point of a reflector 21. To this end, the reflector 21 is provided in particular at its apex S with an aperture 11 that is not shown in FIG. 1 but that is clearly seen in FIG. 1a, and through which the light emitter can be inserted. The light fixture 10 for the prior art also has a housing (not shown) and a socket or mounts (not shown) for the light emitter, electrical lines, and all other required parts and elements, e.g. operating equipment.

The prior-art light fixture 10a illuminates a floor surface B of the building room, approximately in the region between a left limit LB and a right limit RB, and simultaneously illuminates a side wall SE, specifically approximately between a lower limit UB and an upper limit OB. The reflector 21 of the light fixture 10a has a cross-section that is mainly parabolic and is mainly rotationally symmetrical about its center longitudinal axis M. The interior of the reflector is mainly smooth, i.e. there are no segments or bumps formed on the inner surface.

As can best be seen from FIG. 1a, an region of the circumferential angle β is provided with an edge notch 12. The edge notch 12 lets light emitted from the light source at the focal point F fall onto a separate reflector element 13. The reflector element 13 is thus mounted outside the envelope of the reflector 21. The region of the reflector 21 that in FIG. 1 is provided between an upper edge OA and the lower edge UA is thus cut out, which is not clear in FIG. 1 but is clearly shown in FIG. 1a.

Starting from the light source, the light can travel directly to the reflector element 13 without being intercepted by the reflector 21. The broken line L shown in FIG. 1 shows the free edge R of the reflector 21 in the region of the notch 12 before the notch was made.

The reflector element 13 serves to illuminate the side wall SE as high up as possible, that is, as close to the ceiling D as possible. Uniform illumination of the side wall SE is particularly desired.

While the beam bundle that goes out from the light source and that in FIG. 1 is shown in the left-hand half of the reflector 21, to the left of the center longitudinal axis M of the reflector, is reflected on the left-hand reflector half and falls mainly parallel downward onto the floor B, the light striking the element 13 inside the circumferential angle β can illuminate the side wall SE. Thus light distribution that is generally asymmetrical results.

Production of such a reflector like FIGS. 1 and 1a is very complex, since first a mainly rotationally symmetrical reflector must be produced, it must then be punched or cut out, and finally it must be fitted with a separate reflector element 13. In addition, the separate reflector element 13 must be produced separately and during assembly must be positioned very precisely relative to the reflector 21.

In contrast, production of an inventive light fixture that is described in the following is clearly more simple and in particular offers a plurality of advantages in terms of light engineering. An inventive light fixture 10 is first described with reference to FIG. 2:

FIG. 2 shows a first embodiment of an inventive light fixture 10 in a view like FIG. 1.

When viewing FIG. 1, it is initially clear that the inventive light fixture 10 is also suitable for mounting in the ceiling D and for illuminating a building side wall SE and a floor B. For the sake of clarity, the floor B and the lower part of the side wall SE from FIG. 1 have been omitted in FIG. 2.

A comparison of FIG. 1 and FIG. 2 moreover shows how the two reflectors have mainly the same basic shape. Both reflectors 21 are mainly cup-shaped and are of parabolic section. It is immediately apparent that a step-like or sawtooth-like structure is formed on the interior 30 of the reflector 21 for the inventive light fixture 10. This sawtooth-like structure is formed in the embodiment of FIG. 2 by cylindrical segments and is described in detail in the following with reference to FIGS. 2, 3, 4, 4a, 14, and 15.

In a very schematic top view, FIG. 4 shows a view of the interior of the reflector 21 for a light fixture according to the invention like FIG. 2. Here it is clear that a plurality of cylindrical, facet-like segments 14n, 14m, 14i, 14n₁, 14n₂, 14n₃, are arranged on the inner surface 30 of the reflector 21 along a circumferential angle β. As can be seen from the embodiment shown in FIG. 4, the remaining region of the reflector, labeled γ, is facet-free, i.e. is mainly smooth. This facet-free region is labeled THE and represents a partial region of for instance about 250°, while the angularly extending region β is about 110°. Naturally the size of the angularly extending regions β and γ can vary according to the desired application. The number of differently shaped regions can also be varied according to application. FIG. 4a shows an embodiment of an inventive reflector 21 that has been modified relative to FIG. 4 and in which the inner surface 30 of the reflector is entirely filled with cylindrical segments. FIG. 4b shows an embodiment of an inventive reflector 21 that has been modified relative to FIG. 4a.

FIG. 2 shows how a plurality of cylindrical facets 14a, 14b, 14c, 14d, 14e, 14f, 14g, 14h, 14i, 14j, 14k, 14l, 14m, and 14n is are provided starting from an apex S of the reflector 21 to a free edge R of the reflector. FIG. 3a shows the facets 14k, 14l, 14m, 14n in an enlarged partial cut-away view corresponding to circle III in FIG. 2. These are offset cylindrical facets that are arranged adjacent in columns next one another between the apex point and the edge R of the reflector 21.

FIG. 4a shows how a plurality of facets are arranged immediately adjacent one another in the angular direction U. Thus, in FIG. 4a, in the outermost row there are three segments labeled 14n₁, 14n₂, 14n₃, FIG. 4a shows for instance in the sixth outermost row segments labeled 14i₁, 14i₁, 14i₂, 14i₃, and 14ni₄. These four segments are shown in an enlarged view in FIG. 14.

FIG. 14 schematically shows a light source 18 from which a parallel beam bundle is radiated that for instance strikes a surface OF of the cylindrical segment 14i₁. A beam bundle having four parallel beams is shown.

As can be seen as an example using this cylindrical segment 14i₁, the surface OF of each cylindrical segment 14i₁, 14i₂, 14i₃, 14i₄, that is convexly arcuate toward the interior 19 of the reflector 21 and that is formed by a cylinder that is has a radius r, length l, and center axis m. In FIG. 14, the radius r and the cylinder center axis m are shown with a broken line for segment 14i₄. It is significant that each of the cylindrical segments 14i₁, 14i₂, 14i₃, 14i₄ can be defined using its radius r, its cylinder center axis m, and its cylinder length l.

The parameters m, r, and l can vary for the individual segments. In particular the orientation of the cylinder center axis m varies as a function of the spacing of the individual segment from the apex S of the reflector 21 to the orientation of the tangent that can be applied to the reflector at the connecting point or connecting region 15 of the segment.

Due to the curvature of the surface OF with the radius r, the parallel beam bundle that strikes the segment 14i₁ is spread. The four light beams shown in the example have different angles of reflection δ₁, δ₂, δ₃, δ₄, relative to the parallel incident light beams.

All of the other cylindrical segments 14i₂, 14i₃, 14i₄ naturally demonstrate comparable radiating behavior.

The number of segments along a column and the number segments along a row can be freely selected. The number of columns and the number of rows are also freely selectable.

While the curvature of the cylindrical reflecting surface OF can take care of broad homogenization of the light intensity distribution, in accordance with the inventive teaching it is only possible to attain a desired illumination intensity distribution with a special orientation, to be described later, of the cylindrical segments while providing undercuts HI, HM, HN. To this end reference is made initially to FIGS. 2 and 15.

FIG. 15 is an enlarged schematic view of the reflector 21 of the inventive light fixture 10 as in FIG. 2. In this case, all of the cylindrical segments 14a, 14b, 14c, 14d, 14e, 14f, 14g, 14h, 14i, 14j, 14k, 14l, 14m, 14n that are provided in a column are shown. The reflector 21 has an apex S and an edge R, the cross-sectional shape being shaped as a parabola having the focal point F. In terms of its basic shape, the reflector 21 is rotationally symmetrical about the center longitudinal axis M. As can be seen from FIG. 4 and in particular FIG. 4b, however, the cylindrical segments do not have to be distributed rotationally symmetrically.

The cylindrical segments 14a, 14b, 14c, 14d, 14e, 14f, 14g, 14h, 14i, 14j, 14k, 14l, 14m, 14n are each connected to the reflector 21 via a connecting region 15. The part of a cylindrical segment with which each segment meets the basic shape of the reflector is called the connecting region 15. For instance, the segment 14n has a connecting region 15n that is located approximately in the vicinity of a point of intersection Pₙ for the indicated cylinder axis m₄ with the parabolic basic shape of the reflector 21.

A tangent T₄ can be placed on the exterior 38 of the reflector 21 in the region of this point of intersection Pₙ. In terms of its orientation, the tangent T₄ has nothing to do with any structure of the exterior 38 of the reflector 21 and is a tangent in the mathematical sense that is placed on the mathematical curve that produces the basic shape of the cup-shaped curved reflector 21.

In a reflector 21 that is very thin-walled, the external shape 38 of the reflector 21 is nearly the mathematically ideal parabolic curve that produces the basic shape of the reflector, or at least comes very close thereto. The angle between the cylinder axis m₄ and the associated tangent T₄ is labeled α₄ in FIG. 15. α₄ is the so-called deviation mean.

The segment 14, that is closer to the apex than the segment 14ₙ, is similarly fixed to the reflector 21 at its connecting region 151. The associated cylinder axis m₃ intersects the associated tangent T₃ at an angle of deviation α₃. The same applies for all of the other shown cylinder facets, for reasons of clarity in FIG. 15 only the segments 14_{b} and 14f being labeled with their cylinder axes m₁, m₂ and angles α₁, α₂ of deviation.

In particular according to the instant invention, the angles α₁, α₂, α₃, α₄ of deviation vary. The mirror surfaces 16a, 16b, 16c, 16d, 16e, 16f, 16g, 16h, 16i, 16j, 16k, 16l, 16m, 16n, that is, the reflecting surfaces OF, of the individual segments 14a, 14b, 14c, 14d, 14e, 14f, 14g, 14h, 14i, 14j, 14k, 14l, 14m, 14n are inclined differently relative to the center longitudinal axis M of the reflector 21. The inclination of the mirror surfaces 16a, 16b, 16c, 16d, 16e, 16f, 16g, 16h, 16i, 16j, 16k, 16l, 16m, 16n can be selected entirely independent from the basic shape of the reflector 21.

In particular it is possible to illuminate side wall regions SE of a building room up to near the ceiling D by setting the appropriate steepness, preferably of the segments near the edge R of the reflector 21.

The connection or steepness setting for the cylindrical facets 14a, 14b, 14c, 14d, 14e, 14f, 14g, 14h, 14i, 14j, 14k, 14l, 14m, 14n is accomplished such that the cylinder axes m, m₁, m₂, m₃, m₄ assume different angles α₁, α₂, α₃, α₄ of deviation to the associated tangents T₁, T₂. T₃, T₄. The variation in the angles of deviation does not necessarily have to follow certain prespecified rules, such as for instance a rule according to which the angle of deviation for the segment increases from the apex S to the edge R of the reflector. Rather, the angle of deviation can vary as desired. In particular the variation in the angle of deviation is determined by optimizing during a simulation process until a desired illumination intensity distribution is attained.

The inventive teaching also includes light fixtures 10 in which the segments near the apex of the reflector 21 have larger angles of deviation than the segments near the edge R. In addition, individual facets can have larger angles of deviation and other segments, where necessary even adjacent segments can have smaller angles of deviation.

The view of the tangents T₁, T₂, T₃, T₄ as in FIG. 15 is merely schematic. The view of FIG. 15 does not take into account the actual wall thickness of the reflector. When determining the orientation of the tangents, a mathematical curve should be assumed that best corresponds to the curved basic shape of the reflector. This curve is a parabola having the focal point F in the embodiments in FIG. 15 and FIG. 2.

In addition to or as an alternative to production of a high illumination intensity in an upper side wall region, as desired in the embodiment in FIG. 2, if so desired it is also possible, using the connection of the cylindrical facets, which is particularly easy to recognize in FIG. 15, to attain improved homogenization of the illumination intensity distribution on a floor or another surface to be illuminated. Specifically, the reflective surfaces 16a, 16b, 16c, 16d, 16e, 16f, 16g, 16h, 16i, 16j, 16k, 16l, 16m, 16n of the cylindrical segments 14a, 14b, 14c, 14d, 14e, 14f, 14g, 14h, 14i, 14j, 14k, 14l, 14m, 14n can be completely positioned as desired, using simulation programs, in particular using so-called ray tracing methods, the positioning of the facets can be optimized individually according to the desired application.

The use of cylindrical facets has proven to be particularly advantageous during the course of optimizing the illumination intensity distribution. The desired light intensity distributions can be obtained not only with spherical or nonspherically curved segments and also not only with cylindrical segments. In addition to using cylindrical segments, it is advantageous to connect the cylindrical facets such that the mirror surfaces 16a, 16b, 16c, 16d, 16e, 16f, 16g, 16h, 16i, 16j, 16k, 16l, 16m, 16n, that are of the facets and that face the interior of the reflector 21 are oriented entirely freely in their orientation and specifically independent of the basic shape of the reflector.

The inventive teaching can be implemented in a particularly advantageous manner when a cross-sectionally parabolic reflector is to imitate a cross-sectionally elliptical reflector in terms of its light distribution. FIG. 2 shows this embodiment. The light beams sent out to the right starting from the light source in the focal point F all cross at a second focal point F2 outside of the reflector. Thus the cylindrical segments 14a, 14b, 14c, 14d, 14e, 14f, 14g, 14h, 14i, 14j, 14k, 14l, 14m, 14n that are provided on the interior 30 of the mainly parabolic reflector 21 can simulate or imitate the radiation behavior of a mainly elliptical reflector, the cross-sectionally parabolic reflector 21 permitting a much shallower installation depth and installation width than would be required for an elliptical reflector.

Primarily segments that are based on a circular cylindrical body are understood to be cylindrical segments in the sense of this patent application. However, in certain applications there is also the option of selecting as cylindrical basic bodies for the cylindrical facets bodies that do not have a circular cylindrical basic shape and for instance have an elliptical cylindrical cross-section.

FIG. 4 shows an embodiment of a reflector 21 in which only one region of the inner surface 30 of the reflector, which region extends along the circumferential angle β, is filled with cylindrical segments 14n₁, 14n₂, 14n₃, 14l, 14m, 14n, while a partial region THE of the inner surface 30 of the reflector, approximately along the circumferential angle γ, is segment-free and thus is mainly smooth. The embodiment in FIG. 4 is intended to make clear that different sizes and different numbers of partial regions of the inner surface 30 of the reflector 21 can be filled with segments, in particular with cylindrical segments, depending on the application. It should also be noted at this point that a partial region of the reflector 21 can be filled with segments of a first type, for instance with cylindrical segments, and another partial region can be filled with segments of a second type, for instance with spherical segments or nonspherically curved segments or alternatively with a flat surface.

In contrast, FIGS. 4a and 4b show two embodiments of a reflector 21 for an inventive light fixture, the inner surface of which 30 is completely filled with cylindrical segments. With regard to the following description of the figures, it is assumed that the embodiments for FIGS. 4a, and 4b, 5, 8, and 11 have reflectors that have at least a few radial undercuts in the sense of the invention.

FIG. 4a shows an embodiment of a reflector 21 in which the segments are arranged along circular rows. Thus for instance the segments 14n₁, 14n₂, and 14n₃ are arranged along an outermost row of segments and the segments 14i₁, 14i₂, and 14i₃ are arranged along a different, sixth outermost row of segments. The segments 14n, 14m, 14l, 14k are arranged along a column of segments.

In the embodiment in FIG. 4a, the radii of curvature of the individual segments along a row vary. In one alternative embodiment, the radii of curvature can however also be constant along a row. In this alternative embodiment only the orientation of the cylinder axes changes.

FIG. 4b shows an embodiment of a reflector 21 that has been modified relative to FIG. 4a and in which adjacent reflector rows along a circumferential angularly extending region γ₁ are circumferentially offset. The other region of the reflector 21 in FIG. 4b does not have this circumferential staggering.

In the reflector in FIG. 5 the circumferential offset adjacent along an angular region γ₂ becomes particularly clear. There the circumferential angularly extending region labeled γ₂ is filled with rows of cylindrical segments, every two adjacent rows, e.g. rows 17a and 17b or rows 17b and 17c, being arranged circumferentially offset to one another by half a segment width.

On the other hand, the embodiments in FIGS. 8 and 11 do not have this circumferential offset.

It can also be seen from FIG. 5 that the rows 17a and 17c and the rows 17b and 17d do not have this circumferential offset relative to one another. That is, every second row is shaped without a circumferential offset.

Viewed together, it is clear from FIGS. 3, 4a, and 5 that, of the cylindrical segments 14a, 14b, 14c, 14d, 14e, 14f, 14g, 14h, 14i, 14j, 14k, 14l, 14m, 14n, only the cylindrically curved surface OF contributes to the light reflection. The surfaces facing the light outlet aperture of the reflector 21 in FIG. 3 and labeled UF do not have any technical light function. The surfaces labeled UF are shown light in FIGS. 4a and 5, while the cylindrical reflecting surfaces OF in FIGS. 4a and 5 are shown dark.

Moreover, the embodiments in FIGS. 4a, and 4b make it clear that the size of the surfaces UF can be selected entirely different from row to row and also along a row. This clearly results from the different size regions that are shown light in FIGS. 4a and 4b.

It can be seen from FIG. 5 [sic; FIG. 15] that all cylinder axes m₁, m₂, m₃, m₄ of the corresponding segments 14b, 14f, 14i, 14n are set at an acute angle to the center longitudinal axis M of the reflector 21. It can also be seen from FIG. 15 that the segments located near the apex S of the reflector, e.g. the segments 14_{b} and 14_{f}, have quite a small angle of 21° or 5° to the center longitudinal axis M, while the angle of the cylinder axis m₃ of the segment 14i is nearly 0°. In contrast, the cylinder axis m₄ has a large acute angle relative to the center longitudinal axis M.

The variation in the angles of deviation can be seen clearly in FIG. 15. Thus, the angle of deviation α₄ is about 430, while the angle of deviation α₂ is about 34°. Such angles of deviation on the order of magnitude of 5° of the cylinder axes to the associated tangents can be adequate for producing significant changes in the illumination intensity distribution.

At this point it should furthermore be noted that the mirror surfaces 16 of the individual segments 14 each run parallel to the cylinder axes m. Thus for instance the clear mirror surface 16ₙ of the segment 14ₙ in FIG. 15 is arranged parallel to the associated cylinder axis m₄.

Finally, it should be noted at this point that the entire inner surface 30 of the reflector 21 is advantageously filled with cylindrical segments.

A floor B and a wall SE can be illuminated using the embodiment of an inventive reflector 21 like FIG. 5, in particular when using the reflector 21 in an inventive light fixture 10 in an arrangement like FIG. 6 in a ceiling mount. FIG. 6 shows the paths of a plurality of exemplary light beams, assuming that no building side wall is situated along the double arrow SE, but rather that merely a floor is to be illuminated. In fact the light fixture like FIG. 6 also illuminates a side wall SE that extends along the double arrow SE across e.g. a room height of 3 m.

FIG. 7 shows the illumination intensity distribution that results on the side wall SE, approximately between the lower limit UB and the upper limit OB. The width of the wall is given in millimeters on the X axis, and the height of the wall is given on the Y axis. Each 0 point represents the center of the wall, the center longitudinal axis of the reflector 21 for the inventive light fixture 10 like FIG. 6 being arranged at x=0 and y=1500 mm. A wide, uniform illumination intensity distribution can clearly be seen from FIG. 7. The view in FIG. 7 indicates the illumination intensity distribution in a false color view, the illumination intensity decreasing from the inside to the outside. The difference from the prior art is particularly clear when FIG. 7 is compared to FIG. 7a. FIG. 7a shows an illumination intensity distribution for a light fixture from the prior art, specifically a conventional rotationally symmetrical flood reflector. Such a flood reflector from the prior art is rotationally symmetrical about the center longitudinal axis and has a parabolic cross-section. The inner surface is mainly smooth, i.e. without facets or segments. A similar illumination intensity distribution can also result when spherically curved facets are arranged on the interior of a flood reflector.

FIG. 7a shows the illumination intensity distribution on the same scale as FIG. 7, assuming that such a light fixture from the prior art is installed in the ceiling in an installation position like FIG. 7. It is clear that a clearly more uniform illumination intensity distribution that reaches farther upward and outward results with the inventive light fixture using a reflector like FIG. 5, as can be seen from FIG. 7.

An illumination intensity distribution like FIG. 7 cannot be attained just with spherical or nonspherical or otherwise oriented cylindrical facets. Cylindrical facets are required to obtain an illumination intensity distribution like FIG. 7.

FIG. 5 shows an embodiment of an inventive light fixture 10 that can be used for instance as a downlight or even as a spotlight. In both cases, the light fixture 10 illuminates a floor B and a side wall SE.

FIG. 8 is a view like FIG. 5 of another embodiment of a reflector 21 for an inventive light fixture. In terms of its basic shape, the reflector is mainly rotationally symmetrical about its longitudinal center axis M. In this case the curvature radii of the cylindrical segments do not vary along a row of facets. Simply by positioning the segments, i.e. using the positioning of the cylinder axes m relative to the tangents T with different angles a of deviation as described for the embodiment in FIG. 15, an illumination intensity distribution is obtained like FIG. 10 that is characterized by higher uniformity.

FIG. 9 is a schematic illustration of the beam paths using a few exemplary light beams, the light fixture 10 being mounted to the ceiling D and illuminating a floor B. FIG. 9 illustrates the system in an arrangement shown rotated by 180°. FIG. 10 illustrates the illumination intensity distribution of the light fixture 10 like FIG. 9 on the floor B. It is evident that a mainly rotationally symmetrical illumination intensity distribution is obtained that is nearly constant along a large surface circular region.

FIG. 11 illustrates another embodiment of an inventive reflector configuration for an inventive light fixture in which the curvature radii of the cylindrical facets vary along a row of facets. Likewise, in accordance with the inventive teaching the cylindrical segments are positioned such that the cylinder axes have different angles of deviation to the associated tangents. A mainly oval illumination intensity distribution like FIG. 13 can be obtained with an inventive light fixture using a reflector like FIG. 11. With such a light fixture it is possible for instance to illuminate a sculpture so that the reflector 21 like FIG. 11 can be used as a sculpture spotlight. The use of separate sculpture lenses is not necessary when using a reflector 21 like FIG. 11. The polar light distribution curve like FIG. 12 shows the illumination intensity distribution of FIG. 13 along the axes X=0 and Y=0 in a polar, i.e. angle-dependent, view.

FIGS. 15a-22 shall now be used in the following to explain the inventive manufacturing method for an inventive reflector 21 for an inventive light fixture 10.

Preferably the inventive reflector is made from an aluminum disk, i.e. a mainly circular disk made of aluminum, by pressing. FIG. 22, in a very schematic view, illustrates the aluminum disk 23 that is placed on an apex SW of a die 22. The die 22, the so-called male die, and the aluminum disk 23 rotate together about the center longitudinal axis N. The drive required for this is not shown.

A pressing tool includes a pressing head or pusher 24, e.g. a rotatable wheel, and two lever arms 25 and 26 that can pivot about pivot axes 39 and 40, respectively, attached to a stationary attachment site 41. The pressing head 24 moves in the radial direction of the arrow 28 from the center ZE of the aluminum disk 23 outward and is continuously on the top face OS of the aluminum disk 23 and exerts thereon great pressing force in the direction of the arrow 27, that is, in the axial direction. The manner in which the pressing force is exerted by the pusher 24 onto the top face OS of the aluminum disk 23 is as desired and is not shown.

During the pressing process, the pressing head 24 constantly presses the edge of the aluminum disk 23 against the outside face 29 of the die 22. It can follow the shape of the outside face 29 both in the axial direction of the arrow 27 and in the radial direction of the arrow 28. This is possible by means of the pivotable lever arms 25 and 26. It should be noted that the pressing tool with the pressing head 24 and lever arms 25, 26 can have a completely different basic shape, it merely must be assured that the pressing head 24 is able to exert pressing forces in the axial direction 27 and can travel in the radial direction 28.

Starting from a position like FIG. 22, as the die 22 rotates, the pressing head 24 presses, together with the die 22 as the rotating aluminum disk 23 rotates, the disk along the outside surfaces of the die 22 so that the cup-shaped curved basic shape of the reflector 21 results, e.g. like FIG. 15. It should be noted that the cylindrical or spherical segments on the reflector 21 described in the foregoing are worked into the outside shape 29 of the die 22, comprising e.g. hard steel, as a geometrically inverted structure IF, for instance by laser engraving. In cross-section, the outside shape 29 possesses e.g. a sawtooth-like structure. As can be seen for instance from FIG. 15b, the structure on the outside face 29 of the die 22 is impressed in the interior 30 of the reflector 21 after the pressing process has concluded.

While the production of an aluminum reflector for light fixtures with curved segments is already known from applicant's above-described German patent application DE 10 2004 042 915 A1, the production of an aluminum reflector with undercut facets in a pressing process presents problems.

In accordance with the invention, a die 22 is suggested that comprises a plurality of parts that can be displaced relative to one another. In the embodiment in FIGS. 15a and 15b, the die comprises a center part 31, a left-hand edge part 32, and a right-hand edge part 33. The center part 39 runs conically upward and can be displaced in the axial direction of the arrow 27 and in the opposite direction. In this manner it can be inserted like a wedge between and removed from between the two edge parts 32 and 33. The two edge parts 32 and 33 are displaceable radially, at least along a slight displacement path, in the direction of the arrows 28a and 28b as soon as the center part 31 opens an appropriate movement space for the edge parts 32 and 33.

When inserted like FIG. 15a, the edge parts 32 and 33 with the center part 31 form a continuous external shape 29 that is to be impressed on the inner surface 30 of the reflector 21. When withdrawn like FIG. 15b, the center part 31 has been displaced downward relative to the exterior parts 32 and 33 in terms of FIG. 15b. Due to the conical shaping of the center part 31, the wall parts 32 and 33 can be displaced radially inward, which is indicated by the radial arrows 28a and 28b. The edge parts 32 and 33 are prestressed radially inward, for instance by spring elements (not shown).

Due to a radial movement by the edge parts 28a and 28b, the sawtooth-like structures arranged on the edge parts, with their projections VO, can move out of the undercuts HL, HN, HM (see also FIG. 3 and FIG. 3a) that are between the cylindrical facets 14l, 14n, 14m and that are impressed into the reflector 21 so that a movement column 36 results for the edge parts 32, 33. Once the radial displacement of the edge parts 32 and 33 has concluded, this movement gap 36 makes it possible for them to be moved in the axial direction of the arrow 27 out of the inside of the reflector 21 and releases the reflector 21. Thus the die 22 can be removed from the reflector 21 despite the radial undercuts HL, HM, HN on the reflector interior 30.

FIGS. 15c and 15d show another embodiment of an inventive tool 22, in a view approximately along the sectional line XVc-XVc in FIG. 15a. It is clear that this die 22 comprises five parts, in addition to the edge parts 32 and 33 and the center part 31 described in the foregoing, there being other edge parts 34 and 35. In this embodiment of a die 22, once the pressing process has concluded, first the center part 31 moves away from the viewer transverse to the view plane, starting from a position like FIG. 15c, so that then the edge parts 34 and 35 can move radially inward along the arrows 28c and 28d. Then the edge parts 32 and 33 described in the foregoing can move radially inward along the arrows 28a and 28b. The resulting movement space 36 then makes it possible for the entire die 22, the edge parts 32, 33, 34, and 35 and the center part 31, to move axially along the center longitudinal axis M so that the die 22 can be removed entirely from the inside the reflector 21.

The embodiment in FIG. 16 shows another inventive die 22 having three tool parts x, y, and z, each of which has a 120° angular extent. In this case, as well, the view is a top view, similar to the view in FIG. 15c, the reflector 21 not being shown in FIG. 16. FIG. 16 illustrates that only a circumferential angularly extending region z of the die is filled with concave cylindrical or concave spherical or generally inverted facets IF for producing cylindrical or spherical or nonspherical, undercut facets on the corresponding interior 30 of the reflector 21. The other die parts x and y are mainly continuously smooth, i.e. free of bumps or depressions.

Radial movement by the die parts must be possible in order to be able to produce undercut facets 14 on the interior 30 of the reflector 21 by means of the tool part z. Comparing FIGS. 16 and 18, this can happen for instance in that the tool part z executes a radial movement relative to the fixed tool parts x and y along the radial arrow 28e. While FIG. 16 shows e.g. the position of the die 22 that the die assumes during the pressing process, FIG. 18 illustrates the radially inserted position of the die part z after performing a pressing process for removing the die from the reflector 21 that has been formed.

In an alternative embodiment like FIG. 17, the three tool parts x, y, and z move radially outward so that they are spaced apart, as indicated by the double arrows. During the pressing process, the tool parts x, y, and z of the die 22 are in the withdrawn position like FIG. 17, so that the gaps indicated by the double arrows are not closed by a closure part or a plurality of closure parts (not shown) so that these gaps are not pressed onto the interior 30 of the reflector 21. These closure parts can be for instance axially displaceable and, similar to how this is provided in the embodiments in FIGS. 15a and 15b, can be provided with conical exterior surfaces. For the purpose of removing the die, starting from a position like FIG. 17, after the closure parts have executed an axial movement, a radial insertion movement for the three parts x, y, and z can be initiated so that a position like FIG. 16 is attained in which the die 22 can be removed from the reflector 21.

In another embodiment of a die 22 in FIG. 19, it is indicated that the displaceable parts 32, 33 of the die 22 can also perform a pivot movement about a pivot axis 37 located in the region of the foot of the die 22. In an alternative embodiment of the die 22 like FIG. 20, the pivot axis 37 is provided in the head region of the two edge parts 32 and 33.

FIGS. 19 and 20 indicate that, for obtaining undercut facets 14 on the interior 30 of the reflector 21, a corresponding external shape 29 of the die 22 can also be provided along only a partial region of the external shape 29 of the die 22, only those parts or segments of the multi-part die 22 that are provided for generating undercut facets 14 having to be radially displaced.

In contrast, the embodiments in FIGS. 15a through 15d, indicate that projections VO or inverted facets IF that can produce undercut facets on the interior 30 of the reflector 21 can also be provided along the entire outside face 29 of the die 22.

1. A light fixture for the illumination of surfaces of buildings or portions of buildings or exterior surfaces, the fixture comprising an essentially dish-shaped, curved reflector, in an interior of which a light source may be provided and on an inner surface of which a plurality of faceted segments are formed, wherein
at least some of the segments have a reflective surface of basically cylindrical shape centered on a respective cylinder axis and curved toward the interior,
a plurality of the segments are situated between a vertex region and a free edge region of the reflector,
the cylinder axes form with a longitudinal central axis of the reflector respective acute angles varying according to a spacing of the respective segment from the vertex region,
respective tangents at the exterior of the reflector in respective connecting regions of the cylindrical segments form respective deviation angles with the cylinder axis of the associated segment, and
at least some of the deviation angles vary according to a spacing of the respective segment from the vertex region.

2. The light fixture according to claim 1 wherein the light source is a point source.

3. The light fixture according to claim 1 wherein the light source is a metal halide lamp or a low-voltage halogen incandescent lamp, or at least one LED lamp.

4. The light fixture according to claim 1 wherein the reflector has a focal point and the light source is situated close to or in the focal point.

5. The light fixture according to claim 1 wherein the reflector has an essentially parabolic cross section.

6. The light fixture according to claim 1 wherein the reflector has a basic shape that is essentially rotationally symmetrical about the longitudinal central axis.

7. The light fixture according to claim 1 wherein the reflector has an essentially circular light exit opening.

8. The light fixture according to claim 1 wherein the segments are arrayed in rows and radii of curvature of the segments vary along the rows.

9. The light fixture according to claim 8 wherein the light fixture produces a luminous intensity distribution having an essentially oval shape.

10. The light fixture according to claim 1 wherein the light fixture is situated directly on a ceiling of a room in a building, and is designed as a down light.

11. The light fixture according to claim 1 wherein the light fixture is attached directly to a ceiling in a room of a building by means of a conductor track, and is designed as a spotlight.

12. The light fixture according to claim 1 wherein the light fixture illuminates regions of a wall and regions of a floor of the room.

13. The light fixture according to claim 12 wherein the light fixture uniformly illuminates regions of the wall.

14. The light fixture according to claim 1 wherein the light fixture is designed as a pole-mounted light fixture for illuminating parking areas.

15. The light fixture according to claim 1 wherein the segments are arrayed in rows and radii of curvature of the segments are constant in each row.

16. The light fixture according to claim 15 wherein the light fixture produces a uniform luminous intensity distribution within a circular light field.

17. The light fixture according to claim 1 wherein the segments are arrayed in columns and radii of curvature of the segments vary along the columns.

18. The light fixture according to claim 1 wherein the segments are arrayed in columns and radii of curvature of the segments along each column are constant.

19. The light fixture according to claim 1 wherein the cylindrical segments extend only along a partial region of the inner surface of the reflector.

20. The light fixture according to claim 19 wherein the partial region is a circumferential partial region.

21. The light fixture according to claim 19 wherein remaining regions of the inner surface of the reflector are essentially smooth.

22. The light fixture according to claim 19 wherein remaining regions of the inner surface of the reflector are occupied by segments whose surfaces curve spherically toward the interior, or by planar segments.

23. The light fixture according to claim 1 wherein the cylindrical segments extend along the entire inner surface of the reflector.

24. The light fixture according to claim 1 wherein the deviation angles vary in such a way that segments situated near the free edge region of the reflector have larger deviation angles than segments situated near the vertex of the reflector.

25. The light fixture according to claim 1 wherein at least some of the cylindrical segments have radial undercuts.

26. The light fixture according to claim 1 wherein the cylindrical segments are situated along annular circumferentially extending rows, and in radial columns extending from the vertex region to the edge region of the reflector.

27. The light fixture according to claim 1 wherein two rows of segments separated by a space have a circumferential angular offset.
